(19) United States
(12) Patent Application Publication
(10) Pub. No.: US 2015/0210187 A1
(43) Pub. Date: Jul. 30, 2015

(54) LONGITUDINAL ADJUSTMENT DEVICE FOR LONGITUDINALLY ADJUSTING A VEHICLE SEAT

(71) Applicant: Brose Fahrzeugteile GmbH & Co. Kommanditgesellschaft, Coburg, Coburg (DE)

(72) Inventors: Karsten HARLEB, Weitramsdorf (DE); Sven FISCHER, Ahorn (DE); Frank FASSBENDER, Coburg (DE)

(21) Appl. No.: 14/607,919

(22) Filed: Jan. 28, 2015

(30) Foreign Application Priority Data
Jan. 29, 2014 (DE) 10 2014 201 582.0

(51) Int. Cl. B60N 2/07; B60N 2/02

(52) U.S. Cl. CPC B60N 2/0722; B60N 2/0232; B60N 2002/0236

(57) ABSTRACT

A longitudinal adjustment device for longitudinally adjusting a vehicle seat comprises a first guide rail extending longitudinally along a longitudinal direction, and a second guide rail extending longitudinally along the longitudinal direction and being displaceable along the longitudinal direction relative to the first guide rail and having two opposing rail legs and a rail base connecting the rail legs. Arranged on the second guide rail is an actuating device for adjusting the guide rails relative to each other in an actuated state, and/or for retaining the guide rails in a longitudinal position relative to each other in non-actuated state. An angle bracket disposed on the second guide rail for holding the actuating device on the second guide rail is designed U-shaped with two legs and a base connecting the legs.

### CROSS-REFERENCE TO RELATED APPLICATION

This application claims priority to German Patent Application No. 10 2014 201 582.0 filed on Jan. 29, 2014, the entirety of which is incorporated by reference herein.

### BACKGROUND

The invention relates to a longitudinal adjustment device for longitudinally adjusting a vehicle seat.

Such a longitudinal adjustment device comprises a first guide rail extending longitudinally along a longitudinal direction, and a second guide rail extending longitudinally along the longitudinal direction and being displaceable along the longitudinal direction relative to the first guide rail. The second guide rail has two opposing rail legs and one rail base connecting the rail legs with each other. Arranged on the second guide rail is an actuating device for adjusting the guide rail relative to each other in an actuated state, and/or for retaining the guide rail in a longitudinal position relative to each other in a non-actuated state. The actuating device is held on the second guide rail by means of an angle bracket arranged on the second guide rail. The angle bracket is designed as a U-shaped angle bracket with two legs and a base connecting the legs to each other, wherein each of the legs are connected via a first edge to the rail base of the second guide rail, and via a second edge opposite the first edge to the base connecting the legs.

Such a longitudinal adjustment device is known from DE 198 15 283 A1, for example. With this longitudinal adjustment device, the angle bracket is designed as a U-shaped angle bracket with two legs and a base connecting the legs to each other, wherein contact sections abut each of the legs, the angle bracket being fastened to the associated guide rail by means of said contact sections, e.g., screwed to the guide rail.

With such longitudinal adjustment devices for longitudinally adjusting a vehicle seat in a vehicle, the basic problem is that such longitudinal adjustment devices must be designed to be crash-resistant so that an (excessive) forward displacement of the vehicle seat does not occur, or even a release of the vehicle seat from a vehicle floor, particularly in the case of a frontal impact of a vehicle. If the forward displacement of the vehicle seat is too great or if the vehicle seat releases from the vehicle floor, it entails a significant risk of injury to a vehicle passenger.

With a longitudinal displacement device as for example known from DE 198 15 283 A1, the forces acting in a crash are conducted through the angle bracket. This makes it necessary to design the angle bracket sufficiently strong to be able to reliably deflect the forces acting in a crash, and to securely hold a vehicle seat in position in a crash.

To efficiently increase the crash rigidity, provision has conventionally been made for example for an angle bracket to be sufficiently deformable in a crash such that the angle bracket hooks with a spindle guided through the angle bracket such that a spindle nut of an adjusting drive enclosed by the angle bracket is relieved and additional deflection of force via the angle bracket is hence realized.

In a longitudinal adjustment device known from WO 2011/098 161 A1, bracing parts are provided instead of the angle bracket by means of which the adjusting drive is braced against a guide rail in the longitudinal direction. Such bracing parts are not connected to each other by means of a base, and accordingly do not constitute a surrounding enclosure for the adjusting drive on the associated guide rail.

Other longitudinal adjustment devices involving the bracing parts, but not however the angle bracket of the kind addressed here, are for example known from FR 2 872 747 A1, FR 2 882 975 A1 and WO 2009/092946 A2. Because they dispense with a base which connects the bottom edges of the legs, bracing parts known from these documents are subject to different conditions of force and have different space requirements so that such bracing parts are not always useful, possibly depending on the available installation space.

Generally, even force transmission can be enabled by an angle bracket of the kind addressed here, along with prevention of the loss of a gear unit in an installed position, and protection of a gear unit from dust and soiling.

### SUMMARY

An object of the present invention is to provide a longitudinal adjustment device with an angle bracket which is advantageously supported against an associated guide rail. According to the invention as described herein, at least one of the legs of the angle bracket has a first border section extending between the first edge and second edge, and an opposing second border section. Of these border sections, at least one engagement section engages in an engagement opening in one of the rail legs of the second guide rail.

The present invention is based on the concept of creating an additional brace against the associated guide rail in a longitudinal adjustment device by means of side border sections of the legs of the angle bracket. Accordingly, a side border section of at least one leg engages in an associated engagement opening in a rail leg of the second guide rail and thereby braces against the second guide rail in a form-fit, at least in a crash. The border sections of the leg of the angle bracket extend between edges of the leg by means of which the leg is fastened on the one hand to the rail base of the guide rail, and on the other hand is connected to the base of the angle bracket. The border sections accordingly extend between the base of the angle brackets on the one hand, and the rail base of the associated guide rail on the other hand, wherein additional bracing against the guide rail is generated as one or both of these border sections engage in engagement openings in the rail legs of the guide rail.

Each leg of the angle bracket has a first edge that faces the rail base of the second guide rails, and a second edge by means of which the leg transitions into the base of the angle bracket. In this context, an edge is not necessarily to be understood as a sharp termination; rather, the edge can for example also be formed as a curved edge with a radius of curvature (greater than zero). For example, each leg can transition via a first (curved) edge into a contact section to contact the rail base, and via a second (curved) edge into the base of the angle bracket, wherein the retaining section, with its different sections, is preferably made of a single piece such as steel that has been bent (several times).

Preferably, both edge sections of at least one leg engage via an engagement section in an associated engagement opening of an associated rail leg of the second guide rail. More preferably, both border sections of each leg of the angle bracket engage in an associated engagement opening in the rail legs of the second guide rail. A two-sided bracing of the legs of the angle bracket against the rail legs of the guide rail is hence established such that the angle bracket cannot be excessively deformed even under great, unusual stresses in a crash and is hence securely and reliably held in the guide rail.

By an engagement of the border sections of the legs and associated engagement openings in the rail legs of the guide rail, the forward displacement of a vehicle seat in a crash in particular can be greatly reduced. Since the angle bracket can barely deform relative to the guide rail in a crash, only a comparatively small forward displacement of the vehicle seat can occur in a crash (provided that a spindle nut of the adjustment drive can absorb and deflect the forces arising in a crash without destruction of the spindle nut occurring, for example given a design of the actuating device as an adjusting drive for a spindle drive).

Each border section extends in this case between the edges of the associated leg and corresponds to a side border of the leg. If an edge is designed as a curved edge with a radius of curvature (that is not negligibly small), the side border of the edge can also be an element of the border section such that engagement in the top, first or bottom second edge can also be directly established.

If the opposite border sections of a leg of the angle bracket each engage in an associated engagement opening in opposite rail legs of the guide rail, one embodiment can provide that the engagement openings in the opposite rail legs of the guide rail are not arranged at the same height, but at different heights. Correspondingly, the engagement sections in the border sections of the leg are arranged at different heights such that bracing of the leg is provided at different heights by the engagement of the engagement sections in the engagement openings (reference is made in this context to a vertical direction vertical to the plane in which the rail base extends).

An engagement section can for example be formed by a shoulder in the form of a corner at the associated border section. Such a shoulder can for example be shoved into the associated engagement opening upon the insertion of the angle bracket into an interior space in the guide rail formed between the rail legs such that the shoulder comes into engagement with the engagement opening.

Alternately, an engagement section can also be formed by a projection that projects from the associated border section along a perpendicular direction running perpendicular to the rail legs. The projection can for example be designed pin-like and project in a perpendicular direction from the border section.

It is conceivable in this context for the engagement sections to be designed differently on the opposite border sections. For example an engagement section in the form of a shoulder can be provided on one border section of a leg, and an engagement section in the form of a perpendicularly projecting projection can be provided on the opposite other border section.

Preferably in a normal operating state, the engagement section is not in contact with the rail leg in which the associated engagement opening is arranged. In a normal operating state, the engagement section lies with clearance in the associated engagement opening such that no contact arises between the engagement section and the rail leg of the associated engagement opening. Only when a (minor) deformation of the angle bracket arises under extreme stress does the engagement section come into contact with the opening border surrounding the engagement opening such that additional bracing arises between the angle bracket and the associated second guide rail in such a state of an extreme stress.

Because the engagement section(s) lie in the associated engagement openings with clearance in a normal operating state, overcompensation in the bracing of the angle bracket against the associated guide rail is avoided during normal operation of the longitudinal adjustment device which can cause an improvement in the acoustics of the adjusting device in normal operation of the adjusting device and helps reduce stress and resulting sluggishness in the operation of the adjustment device. In the normal operating state, the engagement sections do not assume a bracing function and lie loosely within the associated engagement openings of the second guide rail. Only under extremely high loads in a crash and a resulting (elastic or plastic) deformation of the guide rail arrangement do the engagement sections brace against the second guide rail and thereby enhance the retention of the angle bracket and hence the actuating device on the second guide rail.

The angle bracket is preferably connected by means of at least one, especially two, contact sections to the rail base of the second guide rail, for example screwed, riveted, welded, adhered or crimped to the rail base. Due to the contact sections which abut the first edges of the legs of the angle bracket and are hence opposite the base of the angle bracket, a secure, reliable attachment of the angle bracket to the second guide rail can be achieved. The contact sections preferably extend at an angle such as 90° relative to the legs of the angle bracket.

It is in principle also conceivable and possible in this case for one or both legs to not transition into a contact section but rather for their top, first edge to abut the rail base flush and be attached thereby to the rail base, for example welded to the rail base.

The actuating device for adjusting the longitudinal adjustment device can in particular be designed as an electric motor.

The actuating device can for example be realized by an adjusting drive that has a gearbox lying between the legs of the angle bracket and a spindle nut rotatably enclosed in the gearbox. The spindle nut engages the thread of a spindle non-rotatably disposed on the first guide rail such that, given a rotary movement of the spindle nut, the spindle nut rotates on the spindle and is thereby adjusted longitudinally along the spindle. Accordingly, the guide rails are displaceable relative to each other by rotating the spindle nut.

In order to guide the spindle towards the spindle nut, openings are preferably provided in the legs of the angle bracket which extend through the spindle. The spindle accordingly penetrates the openings in the angle bracket.

To realize a so-called “front drive unit,” it is also conceivable for the adjusting drive to have a spindle nut that is securely connected to a spindle mounted on the second guide rail. In this case, the spindle is moved by rotating the spindle nut. The adjusting drive is in turn affixed via the angle bracket to the associated second guide rail. In this case, the spindle is engaged with the thread of another spindle nut affixed on the first guide rail and rotates to adjust the guide rails on the additional spindle nut to adjust the guide rails.

Alternately, the actuating device can also be designed to manually adjust the longitudinal adjustment device. In this case, the actuating device can be designed such that it locks the guide rails to each other when in a non-actuated state and can be unlocked by manual actuation to longitudinally adjust the guide rails. When in their non-actuated state, the actuating device accordingly serves to hold the guide rails locked in a longitudinal position relative to each other. If the guide rails are to be adjusted, the actuating device can be manually unlocked to enable a longitudinal adjustment of the guide rails relative to each other.

The actuation device can for example have at least one locking pin that extends through an opening in the base of the angle bracket and can be moved in the opening by actuating the actuation device. In the non-actuated state of the actuation device, the locking pin engages in a form-fit manner with an opening in the other, first guide rail to establish a lock between the guide rails. To be unlocked, the locking pin can be moved into the opening of the angle bracket and hence disengage from the opening of the other, first guide rail such that the lock is undone and the guide rails can be adjusted longitudinally relative to each other.

Based on the principle of equivalent parts, the angle bracket can be designed for use both with an adjusting drive operable by an electric motor as well as with a manually-actuated actuation device. An angle bracket can accordingly, for example, both have openings in its legs for a spindle to pass through as well as openings in its base for guiding through one or more locking pins such that an angle bracket can be used either together with an adjusting drive operable by an electric motor, or a manually-actuated actuation device. Accordingly, only a single design of an angle bracket is required which can reduce production costs.

### BRIEF DESCRIPTION OF THE DRAWINGS

The concept on which the invention is based will be further explained below with reference to the exemplary embodiments depicted in the figures.

FIG. 1 shows a perspective view of a longitudinal adjustment device having two guide rails and a spindle drive arranged thereon for longitudinally adjusting the guide rails relative to each other.

FIG. 2 shows a partially cutout view of a top, second guide rail of the longitudinal adjustment device having an adjusting drive arranged thereon.

FIG. 3A shows a separate, perspective view of the top, second guide rail.

FIG. 3B shows a reversed, perspective view of the top, second guide rail.

FIG. 4 shows a separate view of the adjusting drive enclosed in an angle bracket.

FIG. 5 shows a separate view of the angle bracket.

FIG. 6 shows a front view of the angle bracket.

FIG. 7 shows a view into the longitudinal adjustment device viewed along a longitudinal axis along which the guide rails extend.

FIG. 8 shows a sectional view along the line A-A according to FIG. 1.

FIG. 9 shows a view of another exemplary embodiment of an actuation device for use in a longitudinal adjustment device.

FIG. 10 shows a view into a longitudinal adjustment device used in an actuation device according to FIG. 9 viewed along the longitudinal axis.

### DETAILED DESCRIPTION

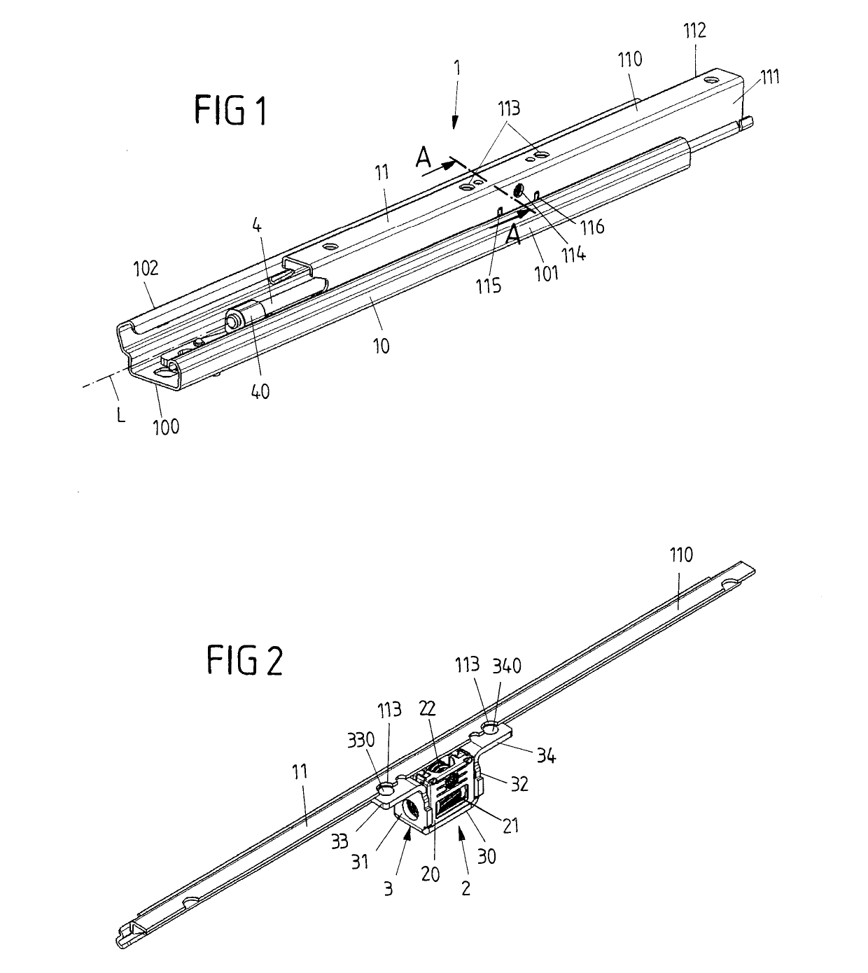

FIG. 1 shows a longitudinal adjustment device 1 for longitudinally adjusting a vehicle seat in a vehicle. The longitudinal adjustment device 1 has a bottom, first guide rail 10 that is for example connected to a vehicle floor, and a top, second guide rail 11 that is connected to a vehicle seat. The guide rails 10, 11 extend along a longitudinal axis L and are mounted so as to be longitudinally movable on each other such that the longitudinal position of a vehicle seat can be adapted by moving the top, second guide rail 11 relative to the bottom, first rail 10.

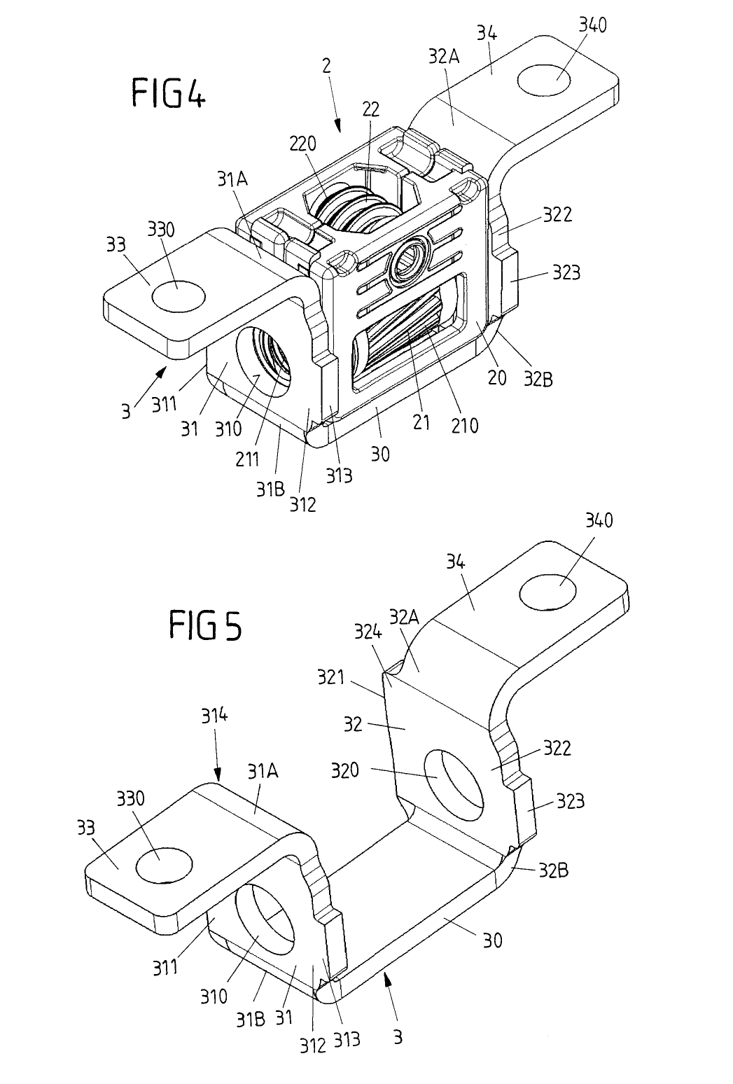

The longitudinal adjustment device 1 is designed to adjust the vehicle seat by an electric motor and has for this purpose a spindle drive with a spindle 4 rotatably disposed on the first guide rail 10 by means of holders 40, and an adjusting drive depicted in FIGS. 2 and 4. The adjusting drive 2 is fixed by means of an angle bracket 3 to the top, second guide rail 11, and comprises a gearbox 20 in which a spindle nut is rotatably mounted about the longitudinal axis L. As can be seen from FIG. 4, the spindle nut 21 has outer teeth 210 that engage with a worm thread 220 of a driving worm 22 such that the spindle nut 21 can be rotated about the longitudinal axis L by rotating the driving worm. The spindle nut 21 furthermore has an inner thread 211 which engages with an outer thread of the spindle 4 such that the spindle nut 21 rolls on the spindle 4 as the spindle nut 21 is rotated relative to the spindle 4, and is thereby adjusted longitudinally along the spindle 4. In this manner, the adjusting drive 2 can be adjusted as a whole, and the top, second guide rail 11 can thereby be adjusted longitudinally relative to the bottom, first guide rail 10.

The top, second guide rail 11 is designed as a rail with a U-shaped cross-section having a horizontally extending rail base 110 and rail legs 111, 112 extending vertically thereto. By means of the rail legs 111, 112, the guide rail lies glidingly between the rail legs 101, 102 of the first, bottom guide rail 10 such that the top, second guide rail 11 is mounted in a longitudinally adjustable manner on the bottom, first guide rail 10. The rail legs 101, 102 of the bottom first guide rail 10 are connected to each other by means of the rail base 100 such that the cross-section of the bottom, first guide rail 10 is designed substantially as a guide rail with a U-shaped cross-section.

The spindle 4 is rotatably held by holders 40 (of which only one is visible in FIG. 1) on the rail base 100 of the bottom, first guide rail 10.

In contrast, the adjusting drive 2 is fixed by the angle bracket 3 to the rail base 110 of the top, second guide rail 11, wherein the angle bracket 3 encloses the perimeter of the gearbox 20 of the adjusting drive 2 which is thereby affixed to the top second guide rail 11.

The angle bracket 3 is designed as a U-shaped angle bracket with a base 30 and legs 31, 32 extending substantially perpendicular thereto (see FIGS. 4 and 5). The base 30—reference is made to the proper installation and proper use of the longitudinal adjustment device 1 in a vehicle—hereby extends substantially horizontally, and abuts the legs 31, 32 at the edges 31B, 32B. At the opposing edges 31A, 32A, the legs 31, 32 transition into horizontally extending contact sections 33, 34 by means of which the angle bracket 3 abuts the bottom side of the rail base 110 of the top, second guide rail 11 and is connected to the rail base 110.

Attachment points 330, 340 in the form of passages are affixed at the contact sections 33, 34 by means of which points the angle bracket 3 is fastened to the attachment points 113 of the rail base 110 of the top, second guide rail 11.

In this context, it is conceivable to screw or rivet the angle bracket 3 to the rail base 110. It is, however, also conceivable to weld or adhere the angle bracket 3 by means of its contact sections 33, 34 to the rail base 110 of the top, second guide rail 11 and thereby integrally connect to the top, second guide rail 11.

The spindle 4 is guided through the angle bracket 3 through openings 310, 320 in the legs 31, 32 in order for the threads of the spindle nut 21 to engage with the spindle 4.

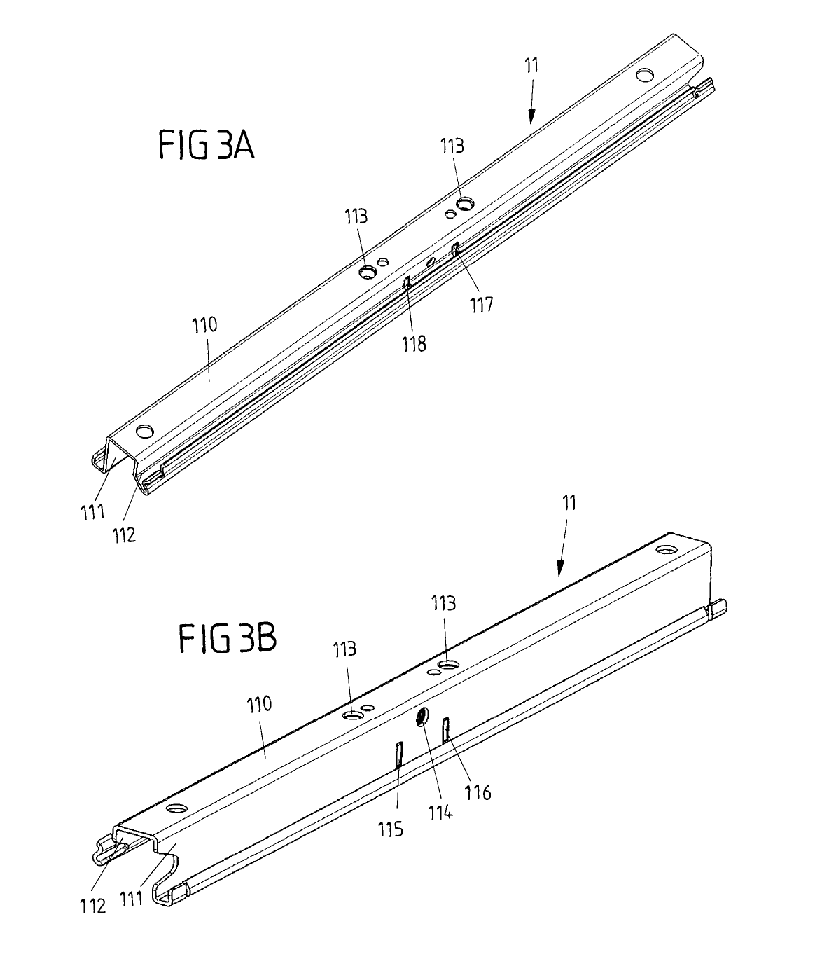

As can be seen from the separate views of the top, second guide rail 11 according to FIGS. 3A and 3B, the top, second guide rail has two engagement openings 115-118 in each of its rail legs 111, 112 that are designed as vertically extending openings in the rail legs 111, 112. Engagement sections 313, 314, 323, 324 on side border sections 311, 312, 321, 322 of the legs 31, 32 of the angle bracket 3 engage in these engagement openings 115-118 to establish additional support of the angle bracket 3 against the top, second guide rail 11 by means of the border sections 311, 312, 321, 322 of the legs 31, 32.

The border sections 311, 312, 321, 322 of the legs 31, 32 are at a distance from each other along a transverse direction Y, and are each assigned to a rail leg 111, 112 of the top, second guide rail 11.

On the border sections 312, 322 (on the front in FIG. 4), the angle bracket 3 has engagement sections 313, 323 in the form of projections projecting at a right angle from the border sections 312, 322 that engage in the manner of pins into the engagement openings 115, 116 in the rail leg 111 (that extends deeper vertically downward than the opposite, other rail leg 112).

In contrast, engagement sections in the form of two shoulders 314, 324 on a top corner of each leg 31, 32 facing the contact section 33, 34 are formed on the opposite border sections 311, 321. These border sections 314, 324 in the form of the shoulders engage in engagement openings 117, 118 in the rail leg 112.

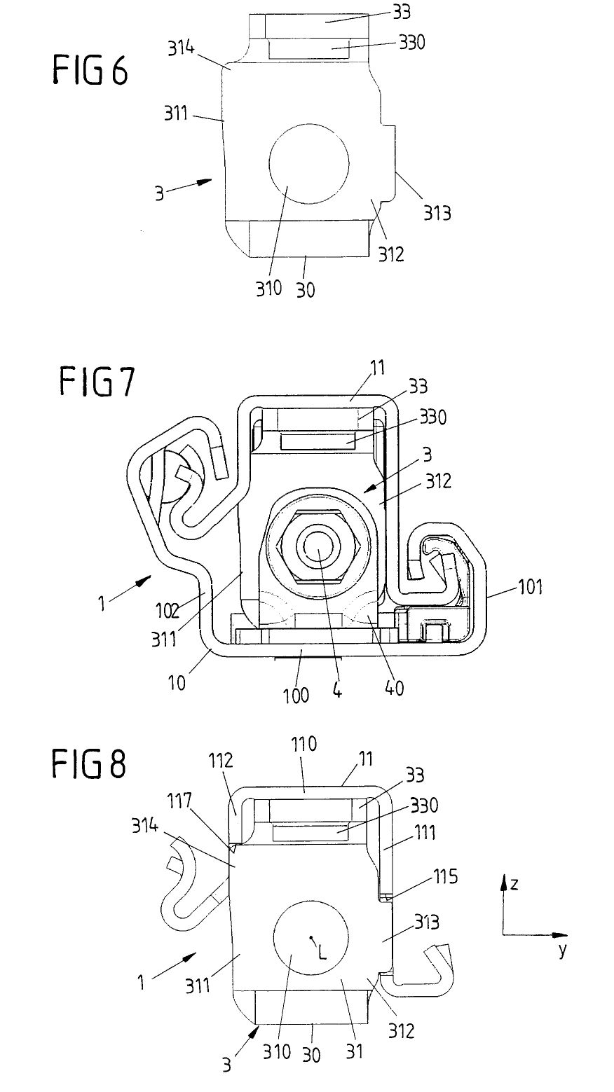

As can be seen from the front views according to FIGS. 6 to 8, the engagement sections 313, 314, 323, 324 lie on the border sections 311, 312, 321, 322 on both sides of the legs 31, 32 of the angle bracket 3 at different heights—viewed along the vertical direction Z. Correspondingly, the engagement openings 115, 116 on the one hand and 117, 118 on the other hand are formed at different heights. On the one hand, this takes into account the different vertical extended lengths of the rail legs 111, 112. On the other hand, this provides a support of the angle bracket 3 against the rail legs 111, 112 of the top, second guide rail 11 at different heights.

As stated, the engagement sections 313, 314, 323, 324 lie in the associated engagement openings 115-118 in the rail legs 111, 112 of the top, second guide rail 11. Preferably, the engagement of the engagement sections 313, 314, 323, 324 in the engagement openings 115-118 has clearance such that the engagement sections 313, 314, 323, 324 do not touch the associated rail legs 111, 112 in a normal operating state, and the legs 31, 32 of the angle bracket 3 do not contact the rail legs 111, 112 of the guide rail 11 in the normal operating state.

The normal operating state corresponds to a state in which the vehicle seat, and hence also the longitudinal adjustment device 1, is exposed to normal stresses. In particular, stress on the vehicle seat from a passenger does not cause the engagement sections 313, 314, 323, 324 to contact the rail legs 111, 112. The clearance between the engagement sections 313, 314, 323, 324 and the rail legs 111, 112 is set such that a deformation of the angle bracket 3 does not cause contact from the stress on the vehicle seat by a vehicle passenger; instead, a certain relative movement between the angle bracket 3 and the rail legs 111, 112 of the top, second guide rail 11 is possible (so-called “rail breathing”).

Since there is no contact in a normal operating state between the legs 31, 32 of the angle bracket 3 and the rail legs 111, 112 of the top, second guide rail 11, the acoustics of the longitudinal adjustment device 1 are improved during operation. Furthermore, undesired tension and tilting of the longitudinal adjustment device 1 from (minor) deformation of the guide rails 10, 11 from stress on the vehicle seat can be avoided.

If however, unusual stresses arise for example in a crash, the engagement sections 313, 314, 323, 324 can come into contact with a border of an associated engagement opening 115, 116, 117, 118 to produce reliable support of the angle bracket 3 by means of its legs 31, 32 against the top, second guide rail 11. Given this support, the angle bracket 3 cannot excessively deform under exceptional stresses, especially in a crash, and an undesired forward displacement in a crash of a vehicle seat connected to a vehicle floor by means of the longitudinal adjustment device 1 can therefore be reliably avoided. The vehicle seat 1 is therefore held in position by the angle bracket 3 such that the safety of the longitudinal adjustment device 1 is increased.

The exemplary embodiment described with reference to FIGS. 1 to 8 serves to adjust a vehicle seat with an electric motor. In particular, the driving worm 22 of the adjusting drive 2 can be driven by an electric motor in order to thereby move the top, second guide rail 11 longitudinally along the longitudinal axis L relative to the bottom, first guide rail 10.

An angle bracket 3 as well as guide rails 10, 11 as described above can, however, also be used for a manually-actuatable longitudinal adjustment device 1.

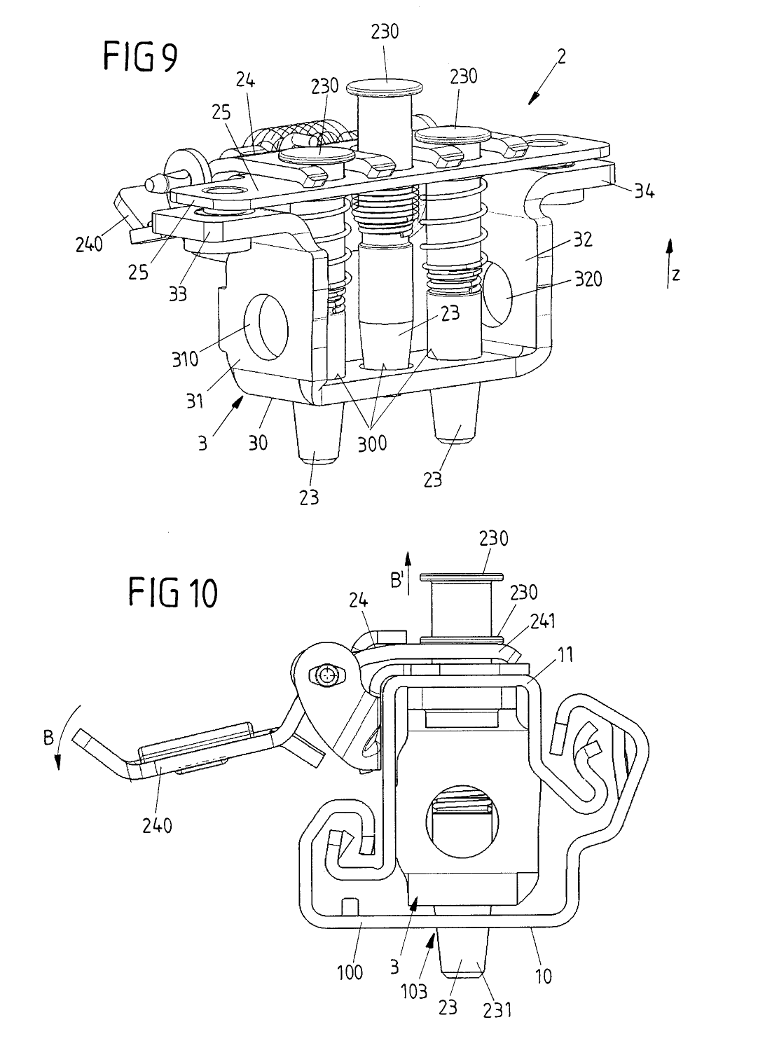

As shown in FIGS. 9 and 10, in such a manually-actuated longitudinal adjustment device 1, a manually-actuated actuation device 2 can be used instead of the adjustment drive driven by an electric motor, said actuating device having at least one locking pin 23—three locking pins 23 in the portrayed exemplary embodiment—that are movably held by means of an attachment plate 24 and the angle bracket 3 of the above-described type to the top, second guide rail 11 along the vertical direction Z. The retaining plate 25 comes to lie on the top side of the rail base 110 of the second guide rail 11 such that the retaining plate 25 and angle bracket 3 accommodate the rail base 110 between them. The locking pins 23 are movably guided in openings 300 in the base 30 of the angle bracket 3.

The actuating device 2 has an actuating lever 24 which is operatively connected by means of a fork-like actuating section 241 to heads 230 of the locking pins 23, and can be manually-actuated by means of a lever arm 240. When the lever arm 240 is swung, the actuating section 241 is lifted, and the locking pins 23 are thereby moved in an upward direction B′ and are adjusted in this manner relative to the angle bracket 3.

In a manner known per se, the locking pins 23 as depicted in FIG. 10 establish, in an non-actuated state, a lock between the top, second guide rail 11 and the bottom, first guide rail 10 as the ends 231 of the locking pins 23 penetrate the openings 103 in the rail base 100 of the bottom, first guide rail 10. Since the locking pins 23 are fixed by means of the angle bracket 3 to a top, second guide rail 10 along the longitudinal axis L, the top, second guide rail 11 is locked relative to the bottom, first guide rail 10.

If the actuating lever 24 is lifted by swinging the lever arm 240 in the actuation direction B and the locking pins 23 are thereby lifted in direction B′, the engagement of the locking pins 23 in the bottom openings 103 of the rail base 100 of the bottom, first guide rail is released such that a lengthwise movement of the guide rails 10, 11 relative to each other is feasible. The longitudinal position of the vehicle seat 1 can be adjusted thereby, wherein after the longitudinal adjustment, the actuating device 2 reaches its locked state and a locking of the guide rails 10, 11 to each other is in turn thereby established.

The angle bracket 3 can be designed identically for use in conjunction with a longitudinal adjustment device 1 operated by an electric motor, or a manually-actuated longitudinal adjustment device 1. The angle bracket 3 can thereby be manufactured according to the principle of equivalent parts which can reduce manufacturing costs.

As can be seen in FIGS. 9 and 10, the openings 310, 320 in the legs 31, 32 for the spindle 4 to pass through remain unused when the angle bracket 3 is used for a manually-actuated actuating device 2. IN contrast, the openings 300 in the base 30 of the angle bracket 3 remain unused when the angle bracket 3 is used for an adjusting drive 2 to be adjusted by an electric motor.

The concept on which the invention is based is not restricted to the previously-described exemplary embodiments, but rather can be realized with completely different types of embodiments.

In particular, it is in principle unnecessary for the angle bracket to be engaged in the associated engagement openings of the rail legs across all the border sections of both legs. It would in principle also be sufficient to establish an engagement only on one border section of one or both legs.

### LIST OF REFERENCE NUMERALS

1 Longitudinal adjustment device
10 11 Guide rail
100 110 Base
101,102 111,112 Leg
103 Opening
113 Attachment points
114 Opening
115-118 Engagement opening
2 Actuating device
20 Gearbox
21 Spindle nut
210 Outer teeth
211 Inner thread
22 Drive worm
220 Worm thread
23 Locking pins
230 Head
231 End
24 Actuating lever
240 Lever arm
241 Actuating section
25 Attachment plate
3 Angle bracket
30 Base
300 Openings
31 32 Leg
31A, 31B, 32A, 32B Edge
310, 320 Opening
311,312 321,322 Border section
313, 323 Projection
314, 324 Shoulder
33, 34 Contact section
330, 340 Attachment point
4 Spindle
40 Holder
B, B′ Actuating device
L Longitudinal direction
Y Transverse direction
Z Vertical direction

1. A longitudinal adjustment device for longitudinally adjusting a vehicle seat, comprising:
a first guide rail extending longitudinally along a longitudinal direction,
a second guide rail extending longitudinally along the longitudinal direction and being displaceable along the longitudinal direction relative to the first guide rail, and having two opposing rail legs and a rail base connecting the rail legs,
an actuating device disposed on the second guide rail for adjusting the guide rails relative to each other in an actuated state, and/or for retaining the guide rails in a longitudinal position relative to each other in non-actuated state,
an angle bracket disposed on the second guide rail for holding the actuating device on the second guide rail, wherein the angle bracket is designed as a U-shaped angle bracket with two legs and a base connecting the legs, wherein the legs are respectively connected via a first edge to the rail base of the second guide rail, and via a second edge opposite the first edge to the base connecting the legs,
wherein at least one of the legs of the angle bracket has a first border section extending between the first edge and the second edge and a second, opposite border section, wherein at least one of the border sections engages with the first engagement section in an engagement opening in one of the rail legs of the second guide rail.

2. The longitudinal adjustment device according to claim 1, wherein both border sections of at least one leg engage in each case by means of an engagement section in an associated engagement opening of an associated rail leg of the second guide rail.

3. The longitudinal adjustment device according to claim 1, wherein each leg engages by means of at least one engagement section on a border section in an associated engagement opening in one of the rail legs of the second guide rail.

4. The longitudinal adjustment device according to claim 1, wherein engagement openings are disposed in the opposing rail legs at different heights viewed along a direction vertical relative to the rail base.

5. The longitudinal adjustment device according to claim 1, wherein an engagement section is formed by a shoulder in the form of a corner on the associated border section.

6. The longitudinal adjustment device according to claim 1, wherein an engagement section is formed by a projection that projects from the associated border section along a direction running perpendicular to the rail legs.

7. The longitudinal adjustment device according to claim 1, wherein the engagement section engages in the associated engagement opening of the second guide rail such that the engagement section, in a normal operating state under the intended stress and use of the longitudinal adjustment device in the longitudinal direction, is not in contact with the rail leg in which the associated engagement opening is disposed but, however, said engagement section comes into contact with the rail leg when the angle bracket is subject to unusual stress.

8. The longitudinal adjustment device according to claim 1, wherein a contact section by means of which the angle bracket is attached to the rail base of the second guide rail abuts the first edge of at least one leg.

9. The longitudinal adjustment device according to claim 1, wherein the first edge, or the contact section abutting the first edge of at least one of the legs, is screwed, riveted, welded, adhered or crimped to the rail base.

10. The longitudinal adjustment device according to claim 1, wherein the actuating device is formed by an adjusting drive for adjusting the guide rails relative to each other by an electric motor.

11. The longitudinal adjustment device according to claim 10, wherein the adjusting drive has a gearbox lying between the legs of the angle bracket and a spindle nut, rotatably disposed in the gearbox that engages in the thread of a spindle non-rotatably disposed on the first guide rail, and that the guide rails can be adjusted relative to each other by rotating the spindle nut.

12. The longitudinal adjustment device according to claim 10, wherein openings through which the spindle extends are disposed in the legs of the angle bracket.

13. The longitudinal adjustment device according to claim 1, wherein the actuating device, in the non-actuated state, is designed to lock the guide rails to each other and can be unlocked by manual actuation to longitudinally adjust the guide rails.

14. The longitudinal adjustment device according to claim 13, wherein the actuating device has at least one locking pin that extends through an opening in the base of the angle bracket and can be moved through the opening by actuating the actuating device.
